(19) United States
(12) Patent Application Publication
(10) Pub. No.: US 2007/0248267 A1
(43) Pub. Date: Oct. 25, 2007

(54) QUANTIFYING GRAPHIC FEATURES OF HANDWRITING FOR ANALYSIS

(76) Inventor: Ze'ev Bar-av, Madison, WI (US)

Correspondence Address: HOWARD M COHN;PATENT ATTORNEY LLC, 21625 CHAGRIN BLVD #220, CLEVELAND, OH, 44122, US

(21) Appl. No.: 11/769,024

(22) Filed: Jun. 27, 2007

Related U.S. Application Data
(63) Continuation of application No. PCT/US06/00695, filed on Jan. 9, 2006.
(60) Provisional application No. 60/642,251, filed on Jan. 7, 2005.

(51) Int. Cl. G06K 9/38

(52) U.S. Cl. 382/186; 382/100

(57) ABSTRACT

A method and apparatus for quantifying graphic features of handwriting, and a system for organizing and reporting analysis results, thereby enabling objective research and evaluation of handwriting. The system includes a standardized list of quantifiable handwriting Features wherein each Feature has a unique alphanumeric reference code; and a standardized list of one or more Sub-features tied to a Feature wherein each Sub-feature is a measurement of the Feature to which it is tied, the measurement resulting in a value for the Sub-feature, and each Sub-feature has a unique alphanumeric reference code. A Feature String is a string of one or more Sub-feature values for uniquely identifying one or more characteristics of the handwriting sample and optionally includes mathematical operations on or between the one or more Sub-feature values. The apparatus is a computer that automates the process of measuring and reporting the handwriting analysis results.

### CROSS-REFERENCE TO RELATED APPLICATIONS

This application is a continuation of copending PCT Patent Application No. PCT/US2006/00695, filed Jan. 9, 2006, which claims the benefit of U.S. Provisional Patent Application No. 60/642,251, filed Jan. 7, 2005, and which is incorporated herein in its entirety by reference.

### TECHNICAL FIELD OF THE INVENTION

The present invention relates to methods and apparatus for analyzing handwriting.

### BACKGROUND OF THE INVENTION

Any form of writing, and especially handwriting, is one of the most complex behaviors of humans. It involves the activation of the brain areas dealing with language, and the ability to have precise fine motor-visual coordination when applying the pen to paper to express one's thinking, emotions, concrete or abstract concept formation. Therefore, just as mental illness is a misnomer, as it is an illness of the neurophysiology, mainly that of the brain, handwriting is in reality brainwriting. In extreme examples, even those who have lost their limbs were able to learn how to write using a pen in his/her mouth. Thus one's handwriting is considered indicative of one's emotional and mental state and one's personality traits.

Graphology, or as it is also known in the USA as Handwriting Analysis, is a field of study that has been in existence for over 100 years. It started in Europe, and over the years migrated to the USA as well as to other countries. Even today, the major weakness of graphology is that it remains a discipline with very little scientific research. Therefore, while its use continues to spread even in the USA, and while many of the Fortune 500 companies use graphology for personnel selection, graphology is not accepted in the US courts for purposes of personality evaluation. The courts do accept testimony of graphologists in Questioned Documents, but even in this area, the graphologist's analysis and subsequent opinion are based on observations rather than precise measurements. Thus the results of graphological analysis are generally considered to be subjective opinion rather than objective science.

Presently, there are the two competing systems dominating graphology. One of the systems that was developed in Europe, also known as the Gestalt system, primarily assesses the overall picture of the handwriting sample in its entirety as being what is most important. The Gestalt system acknowledges the details of the handwriting sample, but stresses that no single graphic feature has an independent meaning. That is to say, in the Gestalt system each given feature is assessed only in view of the total presentation of the handwriting sample.

The second system is the American developed system that is stroke (trait) based. In the American system the handwriting sample analysis starts from the detail of single graphic features and eventually, under the best of circumstances, will consider the overall gestalt of the sample.

Interpretation of either current system is not well supported by academic research, and of the two, the Gestalt system has a better track record with the little research that has been done.

There are presently several handwriting analysis computer programs, but they still rely upon subjective personal observation. The function of the computer program is simply to systematize the analysis by asking the user to look at a graphic feature (e.g., preponderance of loops) or a Gestalt characteristic (e.g., general width of the margins) of the handwriting being analyzed, and then to select the closest one of, say, five handwriting samples that are displayed on the computer screen.

A contrasting system for personality evaluation is the Minnesota Multiphasic Personality Inventory (MMPI) that was developed in the late 1930s by a psychologist and a psychiatrist at the University of Minnesota and was completely revised in 1989, to produce the MMPI-2.

The MMPI and MMPI-2 are based on a statistical evaluation of answers to the questions in a standardized test. Answers to predetermined combinations of the questions are scored and combined to produce a score or percentile rank in each of the “scales”. The MMPI has ten clinical scales and three validity scales plus a host of supplementary scales. The MMPI-2 contains seven validity scales and ten clinical scales that are nearly identical to those of the original MMPI. The validity scales are used to determine if the test answers are being deliberately skewed by the test taker. The clinical scales are identified by reference numbers one through zero (for ten), and the numeric scores for each of the scales can be used in scientific research to determine correlation of scores with psychiatric conditions.

Each of the ten scales was originally thought to indicate the degree of a specific condition (psychiatric diagnostic group). For example, Scale 8 was supposed to indicate schizophrenic tendencies. However, researchers have determined that the scales are not able to be “pure” measures of the psychiatric diagnostic groups, partly because of overlapping symptoms in some of the disorders. Thus, a high score on Scale 8 did not mean that the client was definitely schizophrenic. As a result, the numbers of the scales quickly replaced psychiatric labels for identifying a scale. Thus, instead of talking about the Hypochondriasis Scale, the clinician will talk about Scale 1. Furthermore, researchers also found out that it was common for people to score high on more than one scale at the same time and that interpretations using two or more scales tended to be more sophisticated or refined, more useful, and more accurate. Therefore, patterns of elevations (high score for a scale) were distinguished, and the scale numbers were used as a shorthand to describe which scales had elevations. Thus, a “2-4” meant that there were scores above a “normal” range on Scales 2 and 4, and that Scale 2 had the higher score. The shorthand score (2-4) can be considered a “string” which, like DNA, has a different meaning when the same numbers are placed in a different order (i.e., “2-4” is likely to be different than “4-2”).

When all of the scale's scores are noted (either as a listing or when presented as a graph), the result is called a “profile.” Over the years since institution of the MMPI system researchers have gathered an impressive amount of data on the personality characteristics of those who have taken the MMPI test. Thus correlations can be established between various characteristics and high scores on various scales and combinations of scales such as the 2-4. Relevant clustering has also been found for combinations of three scales, Such as a 4-6-8. (The preceding discussion of the MMPI is excerpted and adapted from “MMPI: Questions To Ask” by Cheryl L. Karp, Ph.D., and Leonard Karp, J. D., as found on the website http://www.falseallegations.com/mmpi-bw.htm).

### ASPECT OF THE INVENTION

An aspect of the present invention is to provide a method and apparatus to quantify graphic features of handwriting, and a system for organizing and reporting analysis results, thereby enabling objective research and evaluation of handwriting.

### SUMMARY OF THE INVENTION

In view of the above, the present invention quantifies essentially every graphic feature of handwriting, be it a full page of text, a brief note, or just a signature. Since this system is measurement driven, it will be easy to incorporate both the Gestalt and the American systems presently.

The present invention measures the graphic features of the written sample and is not limited to either the European or the American systems of observation and interpretation. In fact, the present invention incorporates the features of both systems.

Because the MMPI test is standardized (everyone answers the same questions) and because the Scale scores are numbers that are objectively and consistently calculated by fixed combinations of question answers, the results can be scientifically and statistically correlated with standardized psychiatric diagnostic group classifications. The present invention applies objective measurements to handwriting so that researchers can scientifically and statistically correlate those measurements with personality characteristics. Furthermore, the present invention discloses an organized reporting system so that every graphology researcher can correlate his/her work with the work of other researchers, much like everyone speaking a common language.

Once objective scientific research based on the system of the present invention starts, any observation and any and all interpretive hypotheses will be subject to the scrutiny of research. Thus, in time, those interpretations that are supported by the studies will be validated, and those not supported will be disregarded. Eventually, by focusing on objective measures first, the field of graphology will be given a chance to reach proper integration of the valid points and assumptions of the two current graphology approaches. Those points and assumptions that are not supported during the research can be discarded. Ultimately the entire field of graphology will be unified under one umbrella and the scientific scrutiny of graphology will be the same as other fields that adhere to strict objective and verifiable research.

According to the invention, a method of analyzing a sample of handwriting oil a page is disclosed, the method characterized by the steps of: establishing a standardized list of quantifiable handwriting Features wherein each Feature has a unique alpha-numeric reference code; establishing a standardized list of one or more Sub-features tied to a Feature wherein each Sub-feature is a measurement of the Feature to which it is tied, and each Sub-feature has a unique alphanumeric reference code; measuring the sample to determine numeric values for the Sub-features; and combining one or more Sub-feature values in a Feature String for uniquely identifying one or more characteristics of the handwriting sample; wherein the combining includes a predetermined sequential listing of the one or more Sub-feature values, and optionally includes mathematical operations on or between the one or more Sub-feature values.

Further according to the inventive method, the value of the Feature String is correlated by scientific research with any one or more of: a personal identity, a psychoanalytic diagnosis, and a personality trait of the person that produced the handwriting sample.

According to the invention, the method is further characterized by the step of: using a computer system to automatically measure Features of the handwriting sample. Even further, a step of using the computer system to calculate means and standard deviations for sets of measurement values. Alternatively, the step of using the computer system to measure and calculate the density of handwriting on the page.

According to the invention, the method is further characterized by the step of using the computer system to measure and calculate the pressure of handwriting on the page, optionally using a pressure sensing pad or pen to measure the pressure of handwriting on the page.

According to the invention, the method is further characterized by the steps of: measuring margin sizes; measuring paragraph line vertical spacing; determining pressure of the handwriting; determining pen-line integrity by counting pen-line breaks, counting unnecessary angles, and measuring severity of hand tremor as evidenced by pen-line wiggle; and reporting a Feature String that includes numeric values for the density, the margin sizes, the paragraph line spacing, the pressure, and the pen-line integrity.

According to the invention, the method is further characterized by the steps of: using a grayscale image of the handwriting sample for determining pen-line breaks, handwriting pressure, and handwriting density; and using a binary image of the handwriting sample for determining letter, word, and paragraph line boundaries, and for determining edge contours of the pen-line.

According to the invention, a system for reporting the results of graphalogical analysis of a sample of handwriting on a page is disclosed, the system characterized by: a standardized list of quantifiable handwriting Features wherein each Feature has a unique alphanumeric reference code; and a standardized list of one or more Sub-features tied to a Feature wherein each Sub-feature is a measurement of the Feature to which it is tied, the measurement resulting in a value for the Sub-feature, and each Sub-feature has a unique alphanumeric reference code.

According to the invention, the system is further characterized by: a Feature String of one or more Sub-feature values for uniquely identifying one or more characteristics of the handwriting sample; wherein the Feature String is a predetermined sequential listing of the one or more Sub-feature values, and optionally includes mathematical operations on or between the one or more Sub-feature values.

According to the invention, the system is further characterized by a Sub-feature that reports variability of a set of measurement values, wherein the variability is reported as a standard deviation for the set of measurement values.

According to the invention, a handwriting analysis apparatus is disclosed that includes a computer having a CPU, storage containing a software program to control operation of the apparatus, an input device, an output device and an operator interface; the apparatus characterized by: a method embodied in the software for automatically analyzing a handwriting sample, the method being characterized by: an input module that inputs from the input device an image of the handwriting sample; an image preprocessing module that converts the input image to both a grayscale image and a black-white binary image; a pressure module that uses the grayscale image to determine Pen pressure that was used by the person that wrote the handwriting sample; a text segmentation module that divides the handwriting image into letters, words, and paragraph lines; an edge determination module that determines edge contours and boundaries for the pen-lines that form the handwriting; one or more measurement and calculation modules that determine values for graphic features of the handwriting; and an output module that determines and assigns numeric values to a predetermined list of Features, Sub-features, and Feature Strings according to the rules and definitions of a system of reporting the results of handwriting analysis, and then outputs via the output device a standardized report of the automated handwriting analysis according to the system.

According to the invention, the apparatus is further characterized by: a module that uses a grayscale image of the handwriting sample for determining pen-line breaks and handwriting density.

According to the invention, the apparatus is further characterized by: a measurement and calculation module that uses edge contours to determine the number of interior contours and exterior curves for the letters in the handwriting sample.

According to the invention, the apparatus is further characterized by: a measurement and calculation module that determines the number of vertical, horizontal, negative and positive slopes in the handwriting sample.

According to the invention, the apparatus is further characterized by: a measurement and calculation module that determines the slant, height and width of letters and portions of letters in the handwriting sample.

According to the invention, the apparatus is further characterized by: a computer input device that is a pressure sensing pad or pen; and a software module that uses pressure measurement data from the pressure sensing input device to directly measure the pressure of handwriting on the page.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

The structure, operation, and advantages of the present preferred embodiment of the invention will become further apparent upon consideration of the following description taken in conjunction with the accompanying drawings, wherein:

FIG. 1 is a schematic drawing of a computer system, according to the invention; and

FIG. 2 is a flow chart for the operations of a software program that controls the computer system, according to the invention.

### DETAILED DESCRIPTION OF THE INVENTION

The present disclosure describes both a system and method of measuring every graphic feature of a handwriting sample in conjunction with the development of a “string” of features. Both types of measurements, when taken as a whole, would be so precise that the likelihood that two samples would be exactly the same, would be one out of (two times 10 to the 30^{th} power), that is to say, one divided by a 2 followed by 30 zeros, a number far exceeding the population of the globe.

While most of the measurements suggested herein can be at least approximated by hand, it is much less tedious and significantly more detailed and accurate to have a computer program make the measurements. For example, density of handwriting on a page can be approximated by measuring the margins and maybe even the average spacing between lines, but a computer can count the number of dark pixels on the page to determine a true density. Even without the use of a computer program and even if less than about 30 to 50 basic graphic features of a given handwriting sample are measured, the inventive system and method of measuring and quantifying graphology would greatly increase precision in the way graphology is used, and thus eliminate invalidity and unreliability in the field of graphology.

Exemplary uses of the present system, with or without a computer program, would be, but not limited to, the following:
Document examination
Personality assessment
Personal identification
Detecting deception (probably with a much higher degree of accuracy than the current “lie detector” test)
Creation of behavioral profiles applicable for criminal evaluation and personnel selection
Screening of potential difficulties in school children
Screening for military, police, government or any other area where maximum security is a condition of employment

The present invention will enable scientific research of graphology as it pertains to human behavior. Thus in time, graphology will be another trusted method of personality assessment and will be taught and studied in the psychology departments of our universities.

With the proper application of this method, it could easily become a diagnostic tool for most if not all the diagnostic categories listed in the DSM IV, or the ICD 10, when dealing with psychopathology. Furthermore, graphological analysis has an advantage over other psychological testing tools such as the MMPI in that the person being evaluated does not have to cooperate by taking a test. It is enough to simply obtain, by whatever means, a sample of the person's handwriting. Of course it is best to have the handwriting sample produced in known conditions on standardized paper with a standardized pen and ink, to fill the page, and preferably to include a signature.

Finally, while the system of the present invention is developed using the Latin alphabet and English, with minor modifications it can be used with any written language that is based on an alphabet (e.g., Spanish, Russian, Arabic, Hebrew).

In summary, the inventive system differs from existing graphological document examination in that existing graphology relies primarily on observations to determine an opinion as judged by a graphologist; whereas the inventive system is based entirely on objective measurements. Existing graphology may include a few feeble attempts at “measuring”, but these measures are limited to the approximate size of a Middle Zone (defined hereinbelow), and to overall slant of lines and characters. The inventive system is the first comprehensive measurement system applied to all of the graphic features. Because it is only measurement based, it is applicable to any language based on an alphabet. By contrast, existing graphology analysis has to make major changes from language to language, as each letter of non-Latin alphabets is formed differently than in English. Likewise accent/pronunciation marks (as in French) are more simply accommodated by the inventive system.

It should be noted that the present disclosure uses writing terms such as pen, ink, paper, page, letters, etc. These terms, and others perhaps not listed here, are to be understood in a generic sense interpreted as broadly as possible. The terms are merely exemplary and not limiting. The disclosure applies, wherever possible, to other writing implements and objects to receive the writing. For example, pencil, chalk on state, marker on birch bark, stylus on wax, stylus on pressure sensing pad, etc. are all within the scope of the present disclosure. Likewise, the term “letter” is meant to include any character of any alphabet that forms words from letters in an alphabet. Finally, the Features are first of all directed to script forms of handwriting, and secondarily to block printing. Therefore some of the Sub-feature measurements may have to be adapted or even ignored if printing is being analyzed; for example, Feature 20 concerning the level of connections between letters will only apply in a very limited fashion to printing, i.e., if the writer tends to drag the pen between letters, then there may be connections between some of the letters.

It is an important aspect of the invention to start with those features that are the least susceptible to conscious manipulation by the writer. The slant or the size of the writing are some of the first graphic features a writer will modify when trying to change his/her script. On the other hand, spatial arrangement on a page, integrity of the line (pen-line) that forms and connects written letters, and writing pressure are features that are least susceptible to conscious manipulation. To go beyond subjective observation and make comprehensive objective measurement of the latter critical features, as taught by the present invention, can best be accomplished by a computer. For example, measurement of line integrity, i.e., the quality of the actual pen-line as applied to the paper, involves looking for the slightest indication of hand tremor or breaks in the flow of ink on the paper. This is a critical issue as this is the first aspect to examine when you need to establish the authenticity of the writing and the inherent neurophysiological problems the writer may have, or the first signs of severe anxiety. However, even the best graphology textbooks may make reference to it, but to the inventor's knowledge no one has measured it, or even attempted to, as it is virtually impossible to do unless you enlarge the sample ten or twenty times and then physically go through the entire script to detect the signs of tremor and or breaks. On the other hand, the pixel-by-pixel analysis that can be done by a computer can automate such measurements.

The inventive method involves the use of numbered “Features” that can be combined in strings which uniquely indicate a particular piece of information about the writer, similar to the Scales and shorthand reporting system of the MMPI. Unlike the MMPI, where each Scale has a percentile value, the inventive method's Features will have numeric values that may have significance at any level, not just when the values are high. For example, Feature 7 is the mean letter width in mm (millimeters), so the norm may be somewhere in the middle, and both high and low values may be “abnormal”. On the other hand, research may show that none of the Feature 7 values can be considered abnormal, and all values may signify something of importance. Also, each Feature can have one or more Sub-features, labeled herein with letters following the Feature number. For example, “7a” is shorthand for Sub-feature ‘a’ of Feature 7. The inventive method is not dependent on a particular labeling scheme. For example, it is within the scope of the present invention to call the Features something else (e.g., Measures), and to label the Features and Sub-features with another scheme such as A, B, C and B1, B2, etc. In general, the shorthand labels are most conveniently some logical combination of alphanumeric characters, where the numeric part can be numbers from any numbering system, and the alphabet used can be English, Greek or whatever.

At first each Feature will be defined as a shorthand label or symbol for a particular measurement's numeric value and then research will be able to correlate personality traits, psychological states, etc. with individual Feature values or ranges of values, and also with various combinations of values (Feature string values). Again unlike the MMPI scales, the Feature values lend themselves to mathematical manipulation, such that a Feature string of significance may be a mathematical operation, e.g., dividing (the value of) Feature 7a by (the value of) Feature 5b, or in shorthand “7a/5b”.

Finally, since so little handwriting analysis research has been done using numeric measurement values, the list of Features and Sub-features taught herein should be considered a starting point, albeit a good and comprehensive one. It is expected that future research will determine that certain of these Features/Sub-features are not useful and should be dropped or modified (e.g., changing a difference to a ratio, or e.g., replacing measured values with relative values according to a scale of −3 to +3, or vice versa), while other Features will be enhanced by the addition of new Sub-features; and perhaps entirely new Features will be found to be useful and will be added to the list.

It will be noted that the following listing of Features includes some Features that are actually a combination of several measurements, some of which are separately recorded as other Features. In essence, such Features are shorthand representation for what would otherwise need to be referred to as a Feature string. In the example above of the mathematically manipulated string 7a/5b, if that string becomes commonly used and important, it may be desirable to give it a new Feature or Sub-feature number of its own.

The following is the inventive Feature/Sub-feature list with definitions. Each Feature is labeled with a shorthand Feature number followed by an identifying name. Each Sub-feature of a Feature is labeled by a lower case letter in parentheses. The numeric value or range is underlined and followed by an equal sign and a definition or explanation

1. Spatial Organization

(a) 0 to 100%=density of the written page, i.e., the percentage of the white page that is darkened by handwriting (ink). A computer can give an accurate value by counting dark pixels. To approximate by hand, the width of the margins surrounding the written text are measured and compared to the overall area. i.e., in square inches, of the page so as to determine the percentage of the space used for writing. The hand approximation can be improved by multiplying the number of spaces between lines by an estimated average line spacing and subtracting that product from the written area. Preferably the page is filled top to bottom with writing such that the bottom margin size is determined by the writer. If there is not enough written to “fill” the page, then the page height should be adjusted to produce the same size bottom margin as the top margin.

Using the mean size of each margin (top is Feature 17a, bottom is 17b, left is 17c, and right is 17d) the ratio or balance between the 4 margins of the written page can be determined:
(b) 0.00 to 1.00=ratio of top to bottom margin mean sizes, 17a/17b (top divided by bottom)
(c) 0.00 to 1.00=ratio of left to right margin mean sizes, 17c/17d
(d) 0.00 to 1.00=ratio of top to left margin mean sizes, 17a/17c
(e) 0.00 to 1.00=ratio of top to right margin mean sizes, 17a/17d
   2. Line Integrity
(a) integer=total number of line breaks on the page
(b) number=average number of line breaks per word
(c) integer=total number of tremor wiggles on the page
(d) integer=total number of unnecessary angles on the page
(e) number=average number of unnecessary angles per letter

The second most important feature after choosing the exact spot on the page to put the pen on and where to lift it again, is the integrity of the pen-line used to form the letters and words on the page. The following factors can be considered: How many breaks are there in the line? How many places exhibit tremor? How many unnecessary angles?

All of these factors serve as an indicator of a writer's ability to have full control and mastery of the smooth flow of the pen on the paper. The more interruptions, i.e., breaks, tremor wiggles and unnecessary angles, the more likely it would be that the writer has difficulties in the visual/fine motor-muscular coordination. These interruptions can be tracked by word, character, paragraph line, etc, and statistical calculations can be applied so that the accuracy of the line formation (i.e., line integrity) can be established.

There are qualitative and quantitative differences in the line formation of young children, mature adults, those with neurological problems, neuromuscular problems, those under the influence of both prescribed and illicit drugs, alcohol, fatigue or an emotional arousal that at times would be manifested in the quality of line formation. Line formation is a critical aspect of writing as this is the key feature indicating the possible presence of physiological interference with the process of writing, and as such will be taken into primary consideration before forming interpretive hypotheses on the personality of the individual in question. In analyzing those places where line formation has been disturbed, consideration of the number of such disturbances, as well as the precise words where it takes place will be given. (Sub-features can be added to this list to allow a computer to report the number of disturbances for each word.) Frequently when emotionally stressed, or when lying, pen-line formation is affected. Using the present analysis, the possible source of such a line disturbance will be ascertained, and if it is thought not to be the result of a physiological malfunction, then and only then, will the emotional components be considered.

3. Pressure

(a) 0 to 5=relative pressure of pen on paper, using a scale defined below in this section.

Graphologists generally agree that pressure is a critical element of the written sample. However, to the inventor's knowledge, no one has had an idea about how to objectively measure it. The scale shown below is adapted from the one used for subjective observational graphology.

One way to obtain accurate pressure measurements involves controlled conditions, such as in a research lab. In government departments where personnel identification is critical, a special writing pad can be used to create an imprint of the pressure created by the writer and to measure it with appropriate devices, such as those used to measure computer chips, and derive the individual pressure signature for purposes of identification. Alternatively, a pressure sensing pad or pen could be used and monitored by a computer to form a pressure profile of the signature from beginning to end. As in other aspects of the present system, it would be important to have the individual either sign his/her name, or better yet, increase the sample size by writing at least half of a page in addition to signing his/her name.

Once the measurements are made, it would be important to derive a mean and Standard Deviation (SD) of the measurements. Then statistical calculations can be used to determine a level of confidence that the new handwriting sample has been written by the same or a different person compared to a previous sample.

For less precise requirements, the pressure can be estimated by assuming that darker and wider pen-lines indicate higher pressure writing. With the aid of a computer, the accuracy can be improved somewhat if the computer determines the ink density and width of the pen-lines. It is also helpful to determine the following measurements: Exactly at what parts of a written word does the pressure increase? At what parts does it decrease? Is the change only in the vertical line formation or is it in the horizontal plane as well? Sub-features can be established for these measurements.

The pressure measurement scale for visual observation is as follows. Computer measurements of line width and density will be adapted to this scale as determined by research
0=least amount of pressure applied on the page by the writer, creating a faint line;
1=very light pressure;
2=light pressure;
3=medium pressure, creating a slight groove in the paper;
4=moderate to heavy pressure, creating a groove that is clearly seen/measured on the other side of the written page; and
5=very heavy pressure that is visible to the naked eye as it either has penetrated the paper or has broken through the surface on the other side.
   4. Form Integrity

Using the above measurements, the software will calculate the total number of letters, words, and paragraph lines that have varying degrees of integration/disintegration, where disintegration means poor pen-line integrity due to disturbances defined above. Form integrity is expressed on a scale of 0 to 5, wherein zero indicates no form disintegration (best integrity), and five indicates a high number of places where either letters, words and/or paragraph lines have lost their form integrity. Standard deviations as well as means of the quantity of disturbances per tracked entity (e.g., letter, word, paragraph line, paragraph, page) can be determined and added as additional Sub-features as are useful. The various Sub-feature values will be recorded for identification purposes on the Feature string, and can be used for personality assessment according to research results. The starting set of Form Integrity Sub-features is:
(a) 0 to 5=relative amount of form disintegration for the entire sample
(b) number=average quantity of disturbances per letter
(c) number=average quantity of disturbances per word
(d) number=average quantity of disturbances per paragraph line
   5. Absolute Height

In standard graphology practice, imaginary lines are established across the page to define the vertical boundaries and positions on the page of different elements of the handwritten letters. Letters are said to have three possible “zones”. A middle zone (MZ) contains the bulk and the base of most letters. The lower case letters a, c, e, m, n, o, s, u, v, w, x, z are all “small” letters that are conventionally written within the bounds of the MZ. The line across the bottom of the small letters forms the bottom of the MZ and is called the “baseline”. A baseline is first established for each paragraph line in the writing sample. The line across the tops of the above listed small letters establishes the top, or upper limit of the MZ. Upper case letters and the lower case letters b, d, f, h, k, l are “tall” letters that conventionally extend up above the MZ to the top of an upper zone (UZ), which is the vertical zone between the top of the MZ to the top of the tall letters. Some letters conventionally extend only part way up into the upper zone, like the part of a lower case t above the T-bar, like the dots above i and j, and in some script forms the vertical riser on the left side of a script r. Finally, some letters conventionally extend down below the baseline. The bottom tips of “down-going” lower case letters g, j, p, q, y (and the script form of the lower case f) establish the bottom boundary of a lower zone (LZ) which is the zone between the bottom of the down-going letters and the baseline. In current observational graphology, the baselines and zone boundary lines may be lines that are drawn across the page in a way that approximates an average boundary of the appropriate letters. In more exacting work, the lines may be hand drawn in a connect-the-dots fashion that passes through the lowest or highest LZ, MZ, and UZ point of each appropriate letter. Even then, it is rare to measure more than a few selected zone heights, generally in order to determine a maximum or minimum value. With a computer doing the analysis, however, every letter can be measured to determine LZ, MZ, and UZ heights in mm for every letter, and then the three zone height means and standard deviations (SD) can be calculated for all of the letters in the sample.

Measurements or the Absolute Height Feature 5 are:

(a) number=height in mm of the tallest letter, from the letter's baseline to the top of the letter's UZ
(b) number=height in mm of the tallest MZ for any letter
(c) number=depth of the lowest down-stroke for any letter, i.e., the maximum size LZ
   6. Relative Height

The following measurements are most obtainable using the inventive computer analysis. In conventional graphology, hand measurements can be used to “eyeball” approximate average values (means) for each of the zones. As is true for any other Feature, the herein proposed measures of Relative Height (by taking a difference) may be proved by research to be less useful than measures determined by, for example, ratios, in which case the more useful measures will naturally replace the following measures. Such changes in the way of calculating the value of an inventive Feature such as the Relative Height Feature 6 are within the scope of the present invention.

Measurements of the Relative Height Feature 6 are:

(a) number=Mean MZ Height−Tallest Letter Height, i.e., average MZ value minus Feature 5a value.
(b) Mean MZ Height−Mean UZ Height
(c) Mean MZ Height−Mean LZ Height
(d) Mean LZ Height−Mean UZ. Height
   7. Width of Letters

As with height, the width of each letter in the three zones is best determined by a computerized system, which can then calculate the three zone width means and SDs, for all of the letters in the sample. Practically speaking, with hand measurements the widths can only be eyeball averaged. An MZ width for a letter is defined as the maximum width (in mm) of the portion of that letter that is contained within the MZ. Similar definitions apply to UZ Width and LZ width.

Measurements of the Letter Width Feature 7 are:

(a) number=Mean of the MZ widths (mm), e.g., the average width of the small letter in the middle zone.
(b) number=Mean of the UZ widths (mm)
(c) number=Mean of the LZ widths (mm)
(d) number=the ratio of the three zone width means=MZ mean width divided by UZ mean width divided by LZ mean width (i.e., Sub-feature values 7a/7b/7c)
   8. Letter Slant

The mean and SD of the letter slants per paragraph line and for the sample will be a critical Feature for person identification.

The amount of slant is measured for vertical portions of all letters in the sample and then a mean and SD are calculated. The angle of the slant is measured in degrees around a baseline origin where the degrees increase in a counterclockwise direction from zero degrees (0°) being parallel to the baseline to ninety degrees (90°) being perpendicular upward from the baseline. Thus a slant angle between 0° and 90° indicates a line slanting upward to the right, while a slant angle between 90° and 180° indicates a line slanting upward to the left. Without a computer, the slant angles are eyeball averaged and measured. The Sub-feature values can either be reported in measured degrees or according to a scale that lends itself more readily to hand measurements. The recommended scale is:
−3=greater than 115° (degrees), severe left (backward) slant
−2=110°+/−5°
−1=100°+/−5°
0=90°+/−5°, approximately vertical, no slant
1=80°+/−5°
2=70°+/−5°
3=less than 65°, severe right (forward) slant

Measurements of the Letter Slant Feature 8 are:
(a) number−average letter slant for all of the letters in the sample
(b) number=average letter slant for all of the letters in the signature
(c) number=average letter slant for the letters on the first line of the sample
(d) number=average letter slant for the letters on the second line of the sample
(e) number=average letter slant for the letters on the third line of the sample
(f) number=average letter slant for the letters on the fourth line of the sample
(g) number=average letter slant for the letters on the fifth line of the sample
(h) number=average letter slant for the letters on the sixth line of the sample
(i) number=average letter slant for the letters on the seventh line of the sample
(j) number=average letter slant for the letters on the eighth line of the sample
(k) number=average letter slant for the letters on the ninth line of the sample
(l) number=average letter slant for the letters on the tenth line of the sample

The number value will be reported as a blank (no value) if a line is not present. For a computer evaluation, the signature line number must be input to the computer, or else it will report a blank value. Alternatively, the computer can be programmed to assume that the last line in a sample is the signature line.

9. Baseline Direction

Regardless of the shape/form of a baseline (see Feature 10), this Feature represents the overall average trend of a baseline from left to right. The angle of the baseline trend is measured in degrees relative to a horizontal line that is parallel to the top edge of the paper and is defined as the zero degree trend angle. The trend angle increases from zero as a positive number of degrees for a baseline that trends in an upward direction from left to right. The trend angle decreases from zero as a negative number of degrees for a baseline that trends in a downward direction from left to right.

The baseline trend angle is measured for each paragraph line and a mean and SD can then be calculated for all of the paragraph lines. Without a computer, the trend angles are eyeball averaged and ranked according to a relative scale. The Sub-feature values can either be reported in measured degrees or according to a scale that lends itself more readily to hand measurements. The recommended scale is:
−2=more than −25° (degrees), severe downward direction
−1=−5° to −25°
0—0°−/−5°, approximately level
1=5° to 25°
2—more than 25° (degrees), severe upward direction

Thus the measurements of the Baseline Direction Feature 9 are:
(a) number=average baseline direction for all of the paragraph lines in the sample
   10. Baseline Form

This Feature indicates the overall shape of a baseline, regardless of its trend angle (Baseline Direction Feature 9). The baseline form is determined for each paragraph line and then a mean and SD can be calculated. To determine the overall shape of a baseline, the short range (letter to letter) variations may need to be smoothed out so that a more overall shape can be determined. Since a baseline can be wavy superimposed on an overall cup or arch shaped curve, there are two Sub-features, one to indicate severity of waviness, and another to indicate severity of cup/arch curvature. The severity is measured as the amount of vertical displacement of the baseline, where the displacement is measured from the lowest to the highest point along the baseline. A cup shape is defined as a concave curve that opens upward, and the amount of curvature is indicated as a negative maximum displacement number. An arch shape is defined as a convex curve that opens downward, and the amount of curvature is indicated as a positive maximum displacement number. A wavy shape is defined as a baseline that follow at least one each of the cup and the arch shapes, and its severity is reported as a positive maximum displacement number. Displacement can be reported as measured values in mm, or preferably indicated according to a scale of relative amounts of vertical displacement, wherein the displacement is compared to the Mean Middle Zone Height (MMZH) The recommended scale is as follows:
3—displaced downward more than −1.5*MMZH, severely cupped
−2=−1.0*MMZH to −1.5*MMZH
−1=−0.5*MMZH to −1.0*MMZH
0=+/−0.5*MMZH (displaced up or down half of the MMZH), approximately straight
1=0.5*MMZH to 1.0*MMZH
2=1.0*MMZH to 1.5*MMZH
3=displaced upward more than 1.5*MMZH, severely arched or severely wavy

Thus the measurements of the Baseline Form Feature 10 are:
(a) number=average severity of waviness in the baseline for all of the paragraph lines in the sample
(b) number=average severity of cup/arch curvature in the baseline for all of the paragraph lines in the sample
   11. Relative Word Separation

The mm distance between each pair of words in each paragraph line is measured, and a mean and SD are calculated for all of the word separation distances in the sample. For this Feature, then, the average word separation is reported relative to the width of an uppercase letter M (Mw). The recommended scale is:
−3=less than Mw−2.5 mm, very close, hard to distinguish from letter spacing
−2=Mw−1.5 mm to Mw−2.5 mm, about 2 mm narrower than the letter M
−1=Mw−0.5 mm to Mw−1.5 mm, about 1 mm narrower than the letter M
0=Mw+/−0.5 mm, about the width of the letter M, normal spacing
1=Mw+0.5 mm to Mw+1.5 mm, about 1 mm wider than the letter M
2=Mw+1.5 mm to Mw+2.5 mm, about 2 mm wider than the letter M
3=more than Mw+2.5 mm, unusually far apart

Measurements of Feature 11 are:
(a) scale number=average relative distance between words
   12. Word Separation:

The mm distance between each pair of words in each paragraph line is measured, and a mean and SD are calculated for all of the word separation distances in the sample.

Measurement of Feature 12 are:
(a) number=mean distance between words expressed in mm
   13. Letter Separation

The mm distance between each pair of letters in each word is measured, and a mean and SD are calculated for all of the letter separation distances in the sample.

Measurements of Feature 13 are:
(a) number=mean distance between letters expressed in mm

14. Separation Ratio
(a) number=(Mean Letter Separation) divided by (Mean Word Separation) divided by (Mean MZ Height)
   15. Baseline Spacing

The vertical distance in mm between the baselines of each successive pair of paragraph lines is measured at multiple points along the baselines, and a mean and SD are calculated for the entire sample. A computer program can measure separation at each pixel along a baseline, or at regularly spaced pixels. By hand, the spacing can be approximated by averaging the maximum and minimum baseline spaces.

Measurements of Feature 15 are:
(a) number=mean of all of the baseline spacing measurements for the sample (mm)
(b) number=standard deviation (SD) of all of the baseline spacing measurements for the sample (mm)
   16. Margin Minimum Size

The top, bottom, left and right margins are measured and reported in centimeters (cm) or preferably by using the following scaled values.
1=0to 1 cm
2−1 to 2 cm
3=2 to 3 cm
4=greater than 3 cm

The top minimum margin is measured from the top edge of the page to the highest extent of the top paragraph line of writing. The bottom minimum margin is measured from the bottom edge of the page to the lowest extent of the bottom paragraph line of writing. The left minimum margin is measured from the left edge of the page to the left-most extent of all the paragraph lines of writing. The right minimum margin is measured from the right edge of the page to the right-most extent of all the paragraph lines of writing. In other words each of the four margins is valued according to the minimum amount of white space in the respective margin. With a computerized analyzer, margin measurements can be made at multiple points along the length of the paper edge. For example, top and bottom measurements can be regularly spaced apart (e.g., pixel by pixel) and will measure from the page edge to the respective top UZ line or bottom LZ line. The left and right margin measurements can be made at points spaced along the paper edge at the same level as points within the LZ, MZ, and UZ of each paragraph line. The minimum values can then be selected from each set of margin measurements.

Measurements of Feature 16 are:
(a) number=minimum of all of the top margin measurements
(b) number=minimum of all of the bottom margin measurements
(c) number=minimum of all of the left margin measurements
(d) number=minimum of all of the right margin measurements
   17. Margin Average Size

Using spaced apart measurements as described above for the Margin Minimums Feature 16, means and SD can be calculated for each of the four margins. Values can be reported in cm or preferably by using the scaled values listed in Feature 16.

Measurements of Feature 17 are:
(a) number=mean of all of the top margin measurements
(b) number=mean of all of the bottom margin measurements
(c) number=mean of all of the left margin measurements
(d) number=mean of all of the right margin measurements
   18. Margin Shape

While determining the above described average margin sizes, the margin for each line and for various points along a line will be measured (particularly by a computer). These raw measurements can be used to determine an overall shape for each margin. It may also prove useful to add a Sub-feature that reports either a SD or a range for each set of margin measurements. This would give an idea of how variable the margins are. The shapes are reported as numeric values according to the following scales, wherein the shape referred to is the shape of the edge of the writing to which the margin measurement is made.

The top and bottom margins use this scale:
1=level, generally parallel to the top/bottom edges of the page
2 generally ascending from left to right
3=generally descending from left to right
4=wavy, alternately ascending and descending, thereby creating at least one arch and one cup
5=cupped, concave opening upward
6=arched, convex opening downward

The left and right margins use this scale:
1=vertical, generally parallel to the left/right edges of the page
2=generally slanted upward to the right
3=generally slanted upward to the left
4=wavy, alternately cupping and arching on a large scale
5=cupped, concave opening toward the nearest page edge
6=arched, convex opening away from the nearest page edge
4=jagged, alternately cupping and arching multiple times on a small scale, very irregular paragraph line start/end points

Measurements of Feature 18 are:
(a) scale number=top margin shape
(b) scale number=bottom margin shape
(c) scale number=left margin shape
(d) scale number=right margin shape
   19. Speed

This feature indicates an estimate of how fast the writing was done. Writing speed is presently determined by observing shapes and legibility (which may be hard for a computer to measure) and several interrelated measurable characteristics such as letter width, number of connections, letter slant, and line integrity. Research is still needed to correlate computer readable measurements with this Feature. Writing speed is reported as a numeric value according to the following scale:
0=very slow, looks like it was drawn not written
1=slow, but there is evidence of some spontaneous connections
2=medium speed, average number of connections, still legible
3=fast, looks like it is moving rapidly on the page, begins to be illegible
4=very fast, integrity of letters compromised, hard to read, strong forward slant (upward to right)

Measurements of Feature 19 are:
(a) scale number=average writing speed for whole sample
   20. Connections

This feature indicates the level of connection between letters. The number of connections between adjacent letters is counted and tallied per letter, per word, per line, per paragraph, and for the whole sample. Means and SD are then calculated where appropriate.

Measurements of Feature 20 are:
(a) number=quantity of connections divided by quantity of letters in the sample
(b) number=quantity of connections divided by quantity of words in the sample
(c) number=quantity of connections divided by quantity of lines in the sample
(d) number=quantity of connections divided by quantity of paragraphs in the sample
(e) number=quantity of connections in the sample
   21. PPI

This feature indicates the average or overall formation/shape of the personal pronoun “I” (PPI) in the sample. A list of visual samples of many different forms for the PPI is commonly available for use by graphologists. The present inventive method would standardize such a list and assign a scale number to each of the samples. The value of the PPI Feature 21 would then be reported as the number of the sample that most closely matches the majority of the PPIs in the sample. A computer can apply pattern recognition programming to automate the matching process. Thus the measurement of Feature 21 is:
(a) number=scale number of the closest matching PPI sample
   22. Signature

This feature provides in information about a variety of trait-stroke characteristics as measured/observed in a written signature. Research will have to determine which of these characteristics are important for identifying the person writing the signature. Each characteristic is to be assigned to its own Sub-feature of the Signature Feature 22 (e.g., 22a, 22b, etc.) Present candidates for inclusion in this list of Sub-features are the letter sizes (absolute and/or relative), the quantity in the signature of peaks, angles, arches, cups, hooks, excessive loops, open ovals, double circle ovals, and split Ks. Also there should be scale-determined numeric values for severity of deterioration of letter formation, pen-line formation and overall organization of the script in the signature.

23. T Bar

This feature provides information about the bar that crosses the lower case letter t. Each T bar is measured for height, horizontal length, and degrees plus or minus of bar line slant. Means and SD (averaged over all the T bars in the sample) can be determined where appropriate. Each of these measurement means will be assigned to its own Sub-feature of the T Bar Feature 23, and will be reported in either absolute (mm or degrees), or relative terms (by ratioing with the average letter width or height in the MZ).

24. Arches in Letter Formation

An arch in letter formation is a convex round-top letter formation that is closed on top, open to the bottom. These can occur in any of the three zones, both in normal letter formation, e.g., lower case o in MZ, upper case O in UZ, and even more so in unusual script having excess loops and flourishes, e.g., below the line, rounded off tail of the letter y below the baseline in LZ. Sub-features will include the total number of arches in the sample, the mean number per word, and the mean number per paragraph-line. Standard deviations and/or ratios can also be included if research indicates their usefulness.

25. Arches By Zone

Sub-features here will report the mean number of arches in the UZ per word, and per paragraph line; the mean number of arches in the MZ per word, and per paragraph line; and the mean number of arches in the LZ per word, and per paragraph line.

26. Angles in Letter Formation

An angle in letter formation is any letter formation that substitutes a v type angle or a ˆtype angle for an originally intended round form, as per the copybook letter formation. Sub-features will include the total number of angles in the sample, the mean number per word, and the mean number per paragraph-line. The angles can also be tracked by zone: the mean number of angles in the UZ per word, and per paragraph line; the mean number of angles in the MZ per word, and per paragraph line; and the mean number of angles in the LZ per word, and per paragraph line. Standard deviations and/or ratios can also be included if research indicates their usefulness.

27. Hooks

Hooks are similar to angles, but they can appear anywhere in the script, and they are usually at the beginning or end of any letter. They are important both for identification of a writer and interpretation. Generally, the faster the writing the more likely to see these little hooks, similar to a fishing hook. Sub-features will include the total number of hooks in the sample, the mean number per word, and the mean number per paragraph-line. The hooks can also be tracked by zone: the mean number of hooks in the UZ per word, and per paragraph line; the mean number of hooks in the MZ per word, and per paragraph line; and the mean number of hooks in the LZ per word, and per paragraph line. Standard deviations and/or ratios can also be included if research indicates their usefulness.

Each Feature and Sub-feature listed above, as well as those that we may add in the future will have its own unique permanent location and alpha-numeric designation, like in the DNA string or the MMPI. For example, as the Features are defined at this time, a reference to “7a” is shorthand for “Sub-feature 7a”, which will always refer to the Mean of the MZ Widths (mm).

The foregoing description has presented the inventive method of objectively quantifying graphic features and an accompanying system for reporting the measurements in a way that enables research and greatly improved accuracy in the analysis of handwriting, thereby elevating graphology to a precise science, rather than a subjective art.

It should be apparent that many of the measurements require a computer in order to efficiently and accurately obtain them. Therefore a description of an exemplary embodiment of a suitable handwriting analysis apparatus follows.

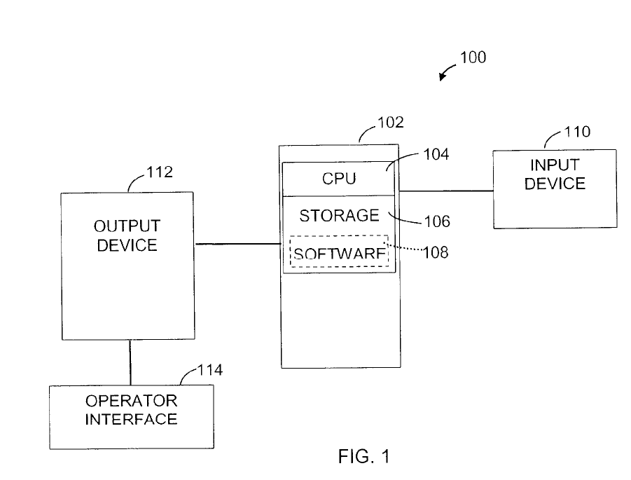

Referring to FIG. 1, a handwriting analysis apparatus (device) 100 is shown in the form of a computer 102 with appropriate input and output devices, 110 and 112 respectively. The computer 102 has a central processing unit (CPU) 104, and one or more storage media 106 that contain a special purpose handwriting analysis program, or software 108 for controlling the operations of the computer 102 in performing automated, or computerized, handwriting analysis. In fact, almost any kind of software driven computer 102 (of sufficient computing power) can be used, and it is the software 108 that makes the computer function as a handwriting analysis device 100 that automates the process/method of handwriting analysis.

The input device 110 is the means for converting a person's handwriting into a digital form (image) that is “computer-readable”, i.e., that can be operated on by the CPU 104 according to the instructions contained in the software 108. If the handwriting was performed on paper, then the input device 110 can be a scanner or even a digital camera. The input device 110 could also be a special pressure sensing pad which is placed under the paper for digitizing the handwriting as it is performed.

Alternatively, a pressure sensing pen could be used. There are many ways of digitizing handwriting, and the input device 110 is meant to encompass any such suitable device. Of course it is often the case that the handwriting will have been digitized elsewhere, in which case the input device 110 will be any suitable means for reading the digitized image of the handwriting into the computer 102. A network connection, an internet connection with email software, and a CDROM reader, are a just a few examples of this type of input device 110. In whatever way, the input device 110 will present to the CPU 104 a digitized representation of the handwriting sample in the form of an image file (e.g., bmp, jpeg, tiff, etc.).

The computer 102 will also have some type of output device 112 for reporting the handwriting analysis results to the user, and will also have an operator interface 114 so that the user can interact with the computer 102. Interaction includes, for example, starting and stopping the device 100, and the analysis program 108; or directing the program 108 to analyze a desired sample out of several that may have been input; or for requesting different formats for the result reporting; etc. Thus, for example, the operator interface 114 can be a keyboard and/or a mouse; and the output device 112 can be a monitor screen and/or a printer and/or a network connection.

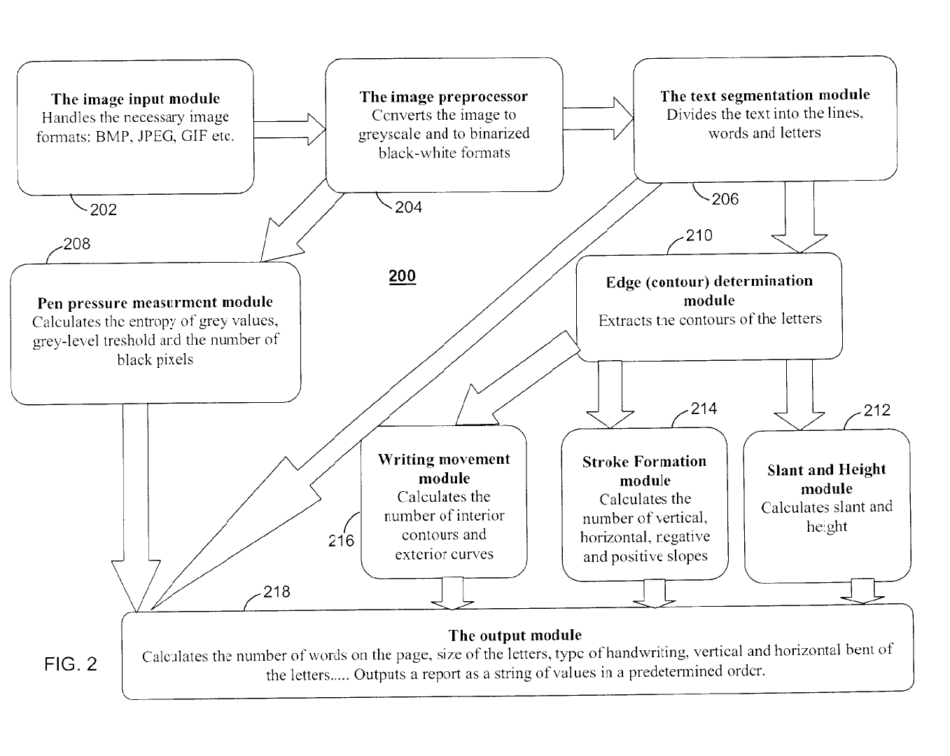

A functional diagram or flowchart 200, is shown in FIG. 2. The flowchart 200 illustrates one possible embodiment of the method steps taken by the software 108 as it controls the computer 102 to perform handwriting analysis according to the present invention. Each method step is performed in a portion of the software 108 called a module, so the terms step and module may be interchanged.

The first step of the program 108, i.e., the first step of the software method 200, is the image input step (module) 202 which converts the image file into a format that is suitable for analysis. The next step is image preprocessing 204, whereby the image is converted into both grayscale format and a binary black-white format. In both formats, the entire area of the handwritten page is gridded into a square array of small rectangular pixels, and each pixel is given a value that represents how dark the pixel is (from the handwriting). The background paper where there is no writing is defined as “white”, i.e., no darkness. In the grayscale format, the non-white pixels are given a number which is proportional to the amount of darkness—for example 0 is white, and 256 is completely black. In the binary format, a threshold is determined, and then every pixel having a gray value below the threshold is labeled white (0) and every pixel above the threshold is labeled as black (1). A threshold is used to handle pixels that are only partly covered by ink.

The grayscale image is passed to the pressure module for the pen pressure measurement step 208. The pressure is deduced from the darkness and width of the pen-lines. This module 208 also calculates the density of writing on the page and the level of connection. It uses the grayscale image because that way, even faint lines (thin, very little darkness) that may be below the black-white threshold will still be counted as written-on pixels. In the case wherein a pressure sensing device is used as an input device 110, then the pen pressure module 208 can use pressure measurement data from the pressure sensing input device 110 to directly measure the pressure of handwriting on the page, including, if desired, a serial record of pressure variation and a calculated SD. Results from the pressure module 208 are passed on to the output module 218 for reporting the pressure, density and connectivity results.

The binary image is passed to the text segmentation module 206 wherein the image is divided into paragraph lines, words, and letters, all of which can be counted and the results passed to the output module 218. Also the margins are measured and their shapes determined, and related statistics are calculated.

In the next step, the edge or contour determination module 210, the edges of all the pen-lines are found so that the breaks in the line can be determined and counted, and the three zone limits can be determined by the location of portions of the letters. This allows setting the baseline, the bottom of the LZ, the top of the MZ and the top of the UZ, thereby enabling the measuring of letter width and baseline form and direction.

The contour information is passed to the next three modules 212, 214, 216 for more measurements. In the slant and height step 212, the slant of the writing and the height of the three zones are measured, along with the slope of the baseline. This information, along with the letter width and baseline statistics, is passed to the output module 218.

In the stroke formation module 214, the number of vertical, horizontal, negative and positive slopes are determined and tabulated by letter, word, and sample. This enables calculation of statistics on stroke characteristics like the T-bar arches, angles, honks, peaks, excessive loops, etc. Results are passed to the output module 218.

The writing movement module 216 calculates the number of interior contours and exterior curves for all the letters. These calculations also contribute to the calculation of various letter formation statistics such as hooks, loops, arches, deterioration of letter formation, etc. Results are passed to the output module 218.

The output module 218 is the last step of the program method 200. The results of measurements and calculations in all the previous steps are gathered here and manipulated as needed to report the results as a string of values according to the inventive system of measurement reporting. The Features and Sub-features are reported in their proper order in a format that is useful to the user. For example, the output could be a printed listing of Sub-feature labels with values, or could be a graphic “profile” presentation of the same results. As significant strings are determined by research, the output report may include desired string results.

Thus the computerized handwriting analysis device 100, under the control of software 108 that implements the analysis method 200 according to the invention, provides an automated apparatus for implementation of the inventive method and system for measuring and reporting results of handwriting analysis.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A method of analyzing a sample of handwriting on a page, the method characterized by the steps of:
establishing a standardized list of quantifiable handwriting Features wherein each Feature has a unique alphanumeric reference code;
establishing a standardized list of one or more Sub-features tied to a Feature wherein each Sub-feature is a measurement of the Feature to which it is tied, and each Sub-feature has a unique alphanumeric reference code;
measuring the sample to determine numeric values for the Sub-features; and
combining one or more Sub-feature values in a Feature String for uniquely identifying one or more characteristics of the handwriting sample; wherein the combining includes a predetermined sequential listing of the one or more Sub-feature values, and optionally includes mathematical operations on or between the one or more Sub-feature values.

2. The method of claim 1, wherein:
the value of the Feature String is correlated by scientific research with any one or more of: a personal identity, a psychoanalytic diagnosis, and a personality trait of the person that produced the handwriting sample.

3. The method of claim 1, further characterized by the step of:
using a computer system to automatically measure Features of the handwriting sample.

4. The method of claim 3, further characterized by the step of:
using the computer system to calculate means and standard deviations for sets of measurement values.

5. The method of claim 3, further characterized by the step of:
using the computer system to measure and calculate the density of handwriting on the page.

6. The method of claim 3, further characterized by the step of:
using the computer system to measure and calculate the pressure of handwriting on the page.

7. The method of claim 6, further characterized by the step of:
using a pressure sensing pad or pen to measure the pressure of handwriting on the page.

8. The method of claim 5, further characterized by the steps of:
measuring margin sizes;
measuring paragraph line vertical spacing;
determining pressure of the handwriting;
determining pen-line integrity by counting pen-line breaks, counting unnecessary angles, and measuring severity of hand tremor as evidenced by pen-line wiggle; and
reporting a Feature String that includes numeric values for the density, the margin sizes, the paragraph line spacing, the pressure, and the pen-line integrity.

9. The method of claim 3, further characterized by the steps of:
using a grayscale image of the handwriting sample for determining pen-line breaks, handwriting pressure, and handwriting density; and
using a binary image of the handwriting sample for determining letter, word, and paragraph line boundaries, and for determining edge contours of the pen-line.

10. A system for reporting the results of graphalogical analysis of a sample of handwriting on a page, the system characterized by:
a standardized list of quantifiable handwriting Features wherein each Feature has a unique alphanumeric reference code; and
a standardized list of one or more Sub-features tied to a Feature wherein each Sub-feature is a measurement of the Feature to which it is tied, the measurement resulting in a value for the Sub-feature, and each Sub-feature has a unique alphanumeric reference code.

11. The system of claim 10, further characterized by:
a Feature String of one or more Sub-feature values for uniquely identifying one or more characteristics of the handwriting sample; wherein the Feature String is a predetermined sequential listing of the one or more Sub-feature values, and optionally includes mathematical operations on or between the one or more Sub-feature values.

12. The system of claim 10, further characterized by:
a Sub-feature that reports variability of a set of measurement values, wherein the variability is reported as a standard deviation for the set of measurement values.

13. A handwriting analysis apparatus including a computer having a CPU, storage containing a software program to control operation of the apparatus, an input device, an output device and an operator interface; the apparatus characterized by:
a method embodied in the software for automatically analyzing a handwriting sample, the method being characterized by:
an input module that inputs from the input device an image of the handwriting sample:
an image preprocessing module that converts the input image to both a grayscale image and a black-white binary image;
a pressure module that uses the grayscale image to determine pen pressure that was used by the person that wrote the handwriting sample;
a text segmentation module that divides the handwriting image into letters, words, and paragraph lines;
an edge determination module that determines edge contours and boundaries for the pen-lines that form the handwriting;
one or more measurement and calculation modules that determines values for graphic features of the handwriting; and
an output module that determines and assigns numeric values to a predetermined list of Features, Sub-features, and Feature Strings according to the rules and definitions of a system of reporting the results of handwriting analysis, and then outputs via the output device a standardized report of the automated handwriting analysis according to the system.

14. The apparatus of claim 13, further characterized by:
a module that uses a grayscale image of the handwriting sample for determining pen-line breaks and handwriting density.

15. The apparatus of claim 13, further characterized by:
a measurement and calculation module that uses edge contours to determine the number of interior contours and exterior curves for the letters in the handwriting sample.

16. The apparatus of claim 13I further characterized by:
a measurement and calculation module that determines the number of vertical, horizontal, negative and positive slopes in the handwriting sample.

17. The apparatus of claim 13, further characterized by:
a measurement and calculation module that determines the slant, height and width of letters and portions of letters in the handwriting sample.

18. The apparatus of claim 13, further characterized by:
a computer input device that is a pressure sensing pad or pen;
and a software module that uses pressure measurement data from the pressure sensing input device to directly measure the pressure of handwriting on the page.
